(19) United States
(12) Patent Application Publication
(10) Pub. No.: US 2006/0212185 A1
(43) Pub. Date: Sep. 21, 2006

(54) Method and apparatus for automatic selection of train activity locations

(76) Inventors: Joseph Wesley Philp, Indialantic, FL (US); Mitchell Scott Wills, Melbourne, FL (US)

Correspondence Address: DUANE MORRIS LLP, Suite 700, 1667 K Street, N.W., Washington, DC, 20006, US

(21) Appl. No.: 11/342,854

(22) Filed: Jan. 31, 2006

Related U.S. Application Data
(63) Continuation-in-part of application No. 10/785,059, filed on Feb. 25, 2004.
(60) Provisional application No. 60/449,849, filed on Feb. 27, 2003.

(51) Int. Cl. G01C 21/00

(52) U.S. Cl. 701/19; 701/200

(57) ABSTRACT

A scheduling system and method for moving plural objects through a system described as a freight railway scheduling system. The scheduling system utilizes a cost reactive resource scheduler to minimize resource exception while at the same time minimizing the global costs associated with the solution. The achievable movement plan can be used to assist in the control of, or to automatically control, the movement of trains through the system. The actual location where an activity is to be performed is automatically selected as a function of one or more specified criteria.

### RELATED APPLICATIONS

This application is a continuation in part of application Ser. No. 10/785,059 filed Feb. 25, 2004, claiming the benefit of U.S. Provisional Application 60/449,849 filed on Feb. 27, 2003.

This application is also one of the below listed applications being concurrently filed:

GEH01 00167 Application Serial No. ______ entitled “Method And Apparatus For Optimizing Maintenance Of Right Of Way”;

GEH01 00168 Application Serial No. ______ entitled “Method and Apparatus for Coordinating Railway Line of Road and Yard Planners”;

GEH01 00169 Application Serial No. ______ entitled “Method and Apparatus for Selectively Disabling Train Location Reports”;

GEH01 00171 Application Serial No. ______ entitled “Method And Apparatus For Congestion Management”;

GEH01 00172 Application Serial No. ______ entitled Method And Apparatus For Automatic Selection Of Alternative Routing Through Congested Areas Using Congestion Prediction Metrics”; and

GEH01 00173 Application Serial No. ______ entitled “Method and Apparatus for Estimating Train Location”.

The disclosure of each of the above referenced applications including those concurrently filed herewith is hereby incorporated herein by reference.

### BACKGROUND OF THE INVENTION

The present invention relates to the scheduling of movement of plural units through a complex movement defining system, and in the embodiment disclosed, to the scheduling of the movement of freight trains over a railroad system, particularly the selection of location at which to perform a desired train activity.

Systems and methods for scheduling the movement of trains over a rail network have been described in U.S. Pat. Nos. 6,154,735, 5,794,172, and 5,623,413, the disclosure of which is hereby incorporated by reference.

As disclosed in the referenced patents and applications, the complete disclosure of which is hereby incorporated herein by reference, railroads consist of three primary components (1) a rail infrastructure, including track, switches, a communications system and a control system; (2) rolling stock, including locomotives and cars; and, (3) personnel (or crew) that operate and maintain the railway. Generally, each of these components are employed by the use of a high level schedule which assigns people, locomotives, and cars to the various sections of track and allows them to move over that track in a manner that avoids collisions and permits the railway system to deliver goods to various destinations.

As disclosed in the referenced applications, a precision control system includes the use of an optimizing scheduler that will schedule all aspects of the rail system, taking into account the laws of physics, the policies of the railroad, the work rules of the personnel, the actual contractual terms of the contracts to the various customers and any boundary conditions or constraints which govern the possible solution or schedule such as passenger traffic, hours of operation of some of the facilities, track maintenance, work rules, etc. The combination of boundary conditions together with a figure of merit for each activity will result in a schedule which maximizes some figure of merit such as overall system cost.

As disclosed in the referenced applications, and upon determining a schedule, a movement plan may be created using the very fine grain structure necessary to actually control the movement of the train. Such fine grain structure may include assignment of personnel by name as well as the assignment of specific locomotives by number and may include the determination of the precise time or distance over time for the movement of the trains across the rail network and all the details of train handling, power levels, curves, grades, track topography, wind and weather conditions. This movement plan may be used to guide the manual dispatching of trains and controlling of track forces, or provided to the locomotives so that it can be implemented by the engineer or automatically by switchable actuation on the locomotive.

The planning system is hierarchical in nature in which the problem is abstracted to a relatively high level for the initial optimization process, and then the resulting course solution is mapped to a less abstract lower level for further optimization. Statistical processing is used at all levels to minimize the total computational load, making the overall process computationally feasible to implement. An expert system is used as a manager over these processes, and the expert system is also the tool by which various boundary conditions and constraints for the solution set are established. The use of an expert system in this capacity permits the user to supply the rules to be placed in the solution process.

There may be a number of train activities normally associated with a station or other pre-determined locations. For example, train crews which are allowed to work a limited number of hours are often changed at a particular station or location within the track system. There may be a number of trains with crew expirations at about the same time in the same geographic area, and it may be desirable to select alternative locations within the geographic area consistent with existing labor agreements.

In another example, the dispatcher may need to set out a number of cars in each of several trains within a geographic area and there may be competition for the location and/or the resources available at the location. In addition, there may be congestion on the routes to the various available locations.

Other examples of local activities to be performed at locations include pickup, engine work, engine change, fueling, and inspection.

It is of course important that the resources necessary to perform the scheduled activity are available at the location selected. The selection of the location is a function of the suitability of the location for the scheduled activity and thus may be dependent on the type of activity, the type of train, the specific train, the direction of travel to and from the location, the available route to and from the location and track utilization by currently planned trains and forecast trains. The movement planner may automatically route trains to and from the locations for local activity and may route the trains incorrectly to locations that are not suitable for the planned activity.

One current solution is to suspend the use of the movement planner altogether in congested geographic areas where long-haul, local industry or yard trains typically perform local activities. This deprives the dispatcher of information as to the location of all trains in that geographic area, including those trains which are not performing local movements, and represents a serious disadvantage in planning the movement of such trains.

An alternative current solution is the designation by the dispatcher of a specific train for manual operation when it approaches such an area. This deprives the dispatcher of the use of computerized planning tools and represents an unjustified allocation of the attention of the dispatcher.

It is accordingly an object of the present invention to permit the dispatcher to have continued access to the movement planner for those trains not engaged in local movements and to avoid manual intervention for such trains, thereby improving the profitability of the overall transportation system. In one embodiment, this is accomplished by the use of default activity routing in which the selection of the location for the scheduled activity is made with reference to one or more predetermined criteria, including statistical data compiled on a location by location basis in a location activity profile.

This and many other objects and advantages of the present invention will be readily apparent to one skilled in the art to which the invention pertains from a perusal of the claims, the appended drawings, and the following detailed description of the preferred embodiments.

### BRIEF DESCRIPTION OF THE DRAWING

FIG. 1 is a flow chart illustrating the process by which the location for the provision of an identified activity is selected.

### DETAILED DESCRIPTION

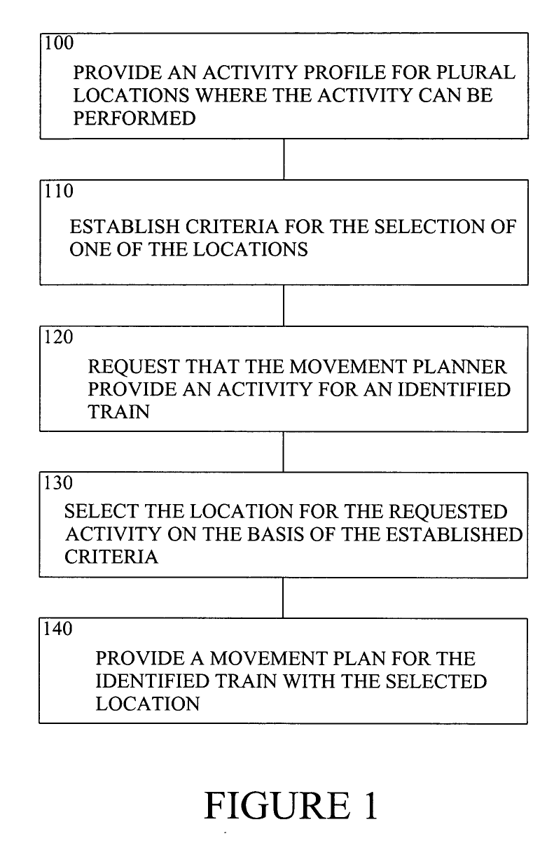

With reference to FIG. 1, a suitable conventional data base may be used to establish for each available location a profile of the activities for which such location is suitable 100. In one embodiment of the present application, criteria are established for the selection of the location for use by the movement planner in the scheduling of an activity for an identified train 110. The criteria may include the type of activity, the type of train, the physical profile of the train, the specific train, the direction of travel to and/or from the location, the route to and/or from the location, and the use of track by both currently planned and forecast trains. Statistical information relating to the specific train, the type of train, the direction of travel to and/or from the location and the type of activity may be incorporated into the activity profile data base based on historical performance.

For example, a specific train routinely traveling between two points may require a crew change in a particular geographic area intermediate the two points in which there are plural locations suitable for a crew change. Based on the direction of travel, one of the locations may be preferred. The accumulation of statistical data favoring such location may be incorporated into the activity profile so that the movement planner will, by default, select such location in planning the movement of the identified train. The use of statistical data will over time improve the selection of the default location for particular trains and types of trains approaching the locations from a specified direction.

Upon receipt of a request that the planner provide an activity for a selected train 120, the planner evaluates the available locations for the requested activity and selects a location as a function of the established criteria 130. For example, a train having a short length may need to have a crew change. The available locations may include a section of main track where the change can take place, and a section of industry track available such that the train could completely clear the main and not block the main during the crew change. The planner could choose the location to be the industry track which would avoid blocking the main track and impacting other trains from using the main 140.

The selection of an available location to perform an activity and the evaluation of the impact of the selection on a movement plan has not been performed previously. This method can be implemented using computer usable medium having a computer readable code executed by special purpose or general purpose computers.

While preferred embodiments of the present invention have been described, it is understood that the embodiments described are illustrative only and the scope of the invention is to be defined solely by the appended claims when accorded a full range of equivalence, many variations and modifications naturally occurring to those of skill in the art from a perusal hereof.

What is claimed is:

1. In a railway scheduling system in which each resource used in each scheduled activity has an incremental cost associated with it, and in which the location at which local activities are to be performed must be selected in the scheduling process, the automatic selection of a location by the movement planner for specifically identified trains to which local movement activities have been scheduled.

2. The system of claim 1 wherein the selection criteria is one of more of (a) the specific train, (b) the type of train and (c) the direction from which the train approaches the location.

3. The system of claim 1 wherein the selection criteria includes the suitability of the location for the type of activity to be provided.

4. The system of claim 3 wherein the type of activity is the setout or pickup for railway cars.

5. The system of claim 3 wherein the type of activity relates to the train locomotive and to one or more of engine work, power change and fueling.

6. In a railroad system in which plural trains are moved along a network of railway tracks under control of a dispatcher assisted by a scheduling computer prepared movement plan that assigns resources to activities and considers the cost of each activity and assigned resources in scheduling the movement of trains over the tracks, a method of automatically selecting a location for the performance of local activity within a geographic area for an identified train comprising the steps of:
(a) establishing an activity profile for each of the available locations within the geographic area;
(b) establishing criteria for the selection of a location;
(c) establishing a movement plan for an identified train requiring a local activity using the established criteria to automatically select a location at which the activity is to be performed.

7. The method of claim 6 wherein the criteria is one or more of (a) the type of activity, (b) the type of train, (c) the specific train, (d) the direction of travel to and/or from the location, (e) the route to and/or from the location, and (f) the use of track by both currently planned and forecast trains.

8. The method of claim 7 wherein the criteria as to (a) the type of activity, (b) the type of train, (c) the specific train, and (d) the direction of travel to and/or from the location includes statistical information.
